(19) United States
(12) Patent Application Publication
(10) Pub. No.: US 2014/0255897 A1
(43) Pub. Date: Sep. 11, 2014

(54) Learning Management System

(71) Applicant: Mark Wayne Salisbury, Albuquerque, NM (US)

(72) Inventor: Mark Wayne Salisbury, Albuquerque, NM (US)

(21) Appl. No.: 13/792,116

(22) Filed: Mar. 10, 2013

(51) Int. Cl. G09B 5/08

(52) U.S. Cl. CPC G09B 5/08
USPC 434/350

(57) ABSTRACT

Disclosed is a “learning and doing” process-oriented learning management system designed to incorporate learning into collaborative work processes by managing work processes for users to submit, review, and approve work products; provide just-in-time access to learning resources for workers to learn how to complete the work products that are intended to result from the collaborative work process; and update the work process where worker/learners collaborate to create/update, review, and approve the learning resources. The learning management system can also manage a large number of collaborative work processes and integrates learning, training, and education on a single platform. In addition, it provides the capability to embed help for using the software into the work processes that the software manages.

### BACKGROUND OF THE INVENTION

1. Field of the Invention

Learning management systems have been around for a long time. Early systems, like the PLATO system which ran on a mainframe computer are over fifty years old. Contemporary web-based systems have appeared within the last decade. Each year more learning management systems try to enter an already crowded market. Given this situation, why file a patent for yet another learning management system? The label “learning management system” is used in this patent application because many of the features and components are best understood within the historical context of learning management systems. However, the invention described in this patent application is as different from a traditional learning management system as a “horseless carriage” is from a traditional carriage drawn by horses.

Traditional learning management systems focus on managing student progress through courses. While the course experience is mediated by a computer, the nature of the assignments, how those assignments are completed, and how they are evaluated are very similar to the experience of historical face-to-face courses. In fact, the computer can be thought of as a “communication device” between the instructor and members of a class that replaces the face-to-face communication. Face-to-face or online, students “go through” the materials, take online quizzes, complete assignments, and receive feedback from the instructor. Training and educational courses are their own “stand alone” experience and are only vaguely related to other “real world” experiences. For example, students of a course on “A Cash Disbursement System for Churches” would step through a managed course on each of the main components of the system they are studying—a requisition slip, a purchase order, a goods inspection report, an invoice verification report, and a check authorization slip. Perhaps, students would “demonstrate” they understood the function of the main components by passing an online quiz. And in many cases, students would take the course months before their church deployed such a system. So, the actual experience of taking the course is almost unrelated to the actual experience of using the system that was the topic of the course. Learning about the work to be done is separated in time and space from actually doing the work. And if the student learns better ways to use the system after they have taken the course, there is no direct way to update the course materials. That's because learning and working are unrelated experiences that are separated by time and space.

This patent is for a new type of learning management system—a process-oriented learning management process including a system that can manage a collaborative work process while providing just-in-time access to learning resources for workers to learn how to complete the work products that are intended to result from the collaborative work process; a collaborative work process for users to collaboratively submit, review, and approve work products; ready access to computer files that serve as learning resources that the worker/learners of the collaborative work process use to learn how to complete the work products; an “update process” to the work process where worker/learners collaborate to create/update, review, and approve the learning resources.

2. Description of Prior Art

There have been a number of patents and patent applications for learning management systems in this tradition. An example is U.S. Pat. No. 7,293,025, titled, “Hosted Learning Management System and Method for Training Employees and Tracking Results of Same.” (Table 1, below lists this and the other Prior Art references.) It outlines a number of parameters and processes for tracking student course completion. However, the course experience, the nature of the assignments, how those assignments are completed, and how they are evaluated are very similar to the experience of historical face-to-face courses. While other recent patent applications may sound like the functionality described in this patent application, they too deliver this traditional face-to-face experience to students. For example, patent application, publication number, US 2006/0008788 A1, entitled “Method and System for Work-Embedded Learning and Group Facilitation Using a Computer-Delivery System” employs computer support for facilitating group work in a face-to-face setting. This may improve face-to-face exercises such as constructing a vision statement, but it is not intended for coordinating work and learning as the invention described in this patent application.

The invention described in this patent application puts work and learning and in the same time and space dimension. That is, it embeds the learning needed to complete the work right in the work processes themselves. In the above example of deploying a cash disbursement system for churches, learning what to do, why to do it, how to do it, and when and where to do it, is embedded in the processes for deploying a cash disbursement system for a church. The “learning while working” process-oriented learning management system facilitates organizational processes by providing collaboration features, just-in-time learning, capture of lessons learned, and evaluation and recording of individual and team learning. As described in the paragraphs below, this invention not only embeds the learning of skills like those in traditional training courses (like the example of deploying a cash disbursement system for a church), it can also embed “higher level” learning on industry methods and professional practices. This capability allows members of organizations to instantly put “theory into practice” by immediately applying industry methods and professional practices through the application of those skills. Furthermore, this invention aligns informal learning in organizations with industry methods, which can be, in turn, aligned with professional practices. This means that the learning management system described in the text below is not just another carriage in the stable of learning management systems, but rather a true invention of the magnitude of the horseless carriage.

### REFERENCES CITED

TABLE 1
U.S. Patent Documents

| | | | As- |
|---|---|---|---|
| Title | Publication Number | Filing Date | signee |
| Web-Deployed E- | US 2006/0134593 A1 | Dec. 21, 2005 | |
| Learning Knowledge | | | |
| Management System | | | |
| Method and System | US 2006/0008788 A1 | Jul. 9, 2004 | IBM |
| for Work-Embedded | | | |
| Learning and Group | | | |
| Facilitation Using a | | | |
| Computer-Delivery | | | |
| System | | | |
| Work-Context Search | US 2007/0143275 A1 | Dec. 21, 2005 | IBM |
| Strings Far Work | | | |
| Embedded Learning | | | |
| Instructional | US 2003/0194690 A1 | Feb. 6, 2003 | |
| Architecture for | | | |
| Collaborative E- | | | |
| Learning | | | |
| Categorizing and | US 2005/0131849 A1 | Dec. 16, 2003 | IBM |
| Sharing Learning | | | |
| Objects | | | |
| Creation of | US 2005/0102322 A1 | Nov. 6, 2003 | IBM |
| Knowledge and | | | |
| Content for | | | |
| Learning Content | | | |
| Management System | | | |
| Hosted Learning | U.S. Pat. No. | Mar. 31, 2004 | |
| Management System | 7,293,025 | | |
| and Method for | | | |
| Training Employee | | | |
| and Tracking | | | |
| Results of Same | | | |

### Other Publications

Hall, J. (2008). Accounting Information Systems, South-Western Cengage Learning, Mason, Ohio.
Vargo, R. (1995). The Church Guide to Internal Controls, Christian Ministry Resources, Big Sandy, Tex.

### SUMMARY OF THE INVENTION

### Business Processes

FIG. 1 shows the two main types of business processes for this invention. The one on the left hand side of FIG. 1 is work process for collaboratively creating an “intermediate” knowledge product—such as a requisition slip, a document template, or system design for a purchases and cash disbursement system. Members of the work process collaboratively create, review, and approve the knowledge products. The “data” box that is available to the members of the work process—to the right of the work process—contains learning resources that the worker/learners of the work process use to learn how to complete the knowledge products in the work process.

The other main type of business process, shown on the right had side of FIG. 1, is an associated “update process” to the work process where worker/learners collaborate to create/update, review, and approve learning resources. This allows the update and creation of new learning resources for improving individual and team performance in completing the knowledge products in the work process.

FIG. 2 shows how this invention “layers” and aligns these processes for creating knowledge products. In the center of FIG. 2, the hardware layer uses functions to produce data. In the next layer, the software layer uses software procedures to produce information. This invention, described in this patent application, creates the outer layers of organizational processes, industry methods, and professional practices. Each one of these layers has work processes and their associated update processes for the learning resources. In the organizational process layer, worker/learners access the process steps, instruction, examples, and expert advice learning assets to learn how to complete organizational processes. In the next layer, industry methods, workers/learners access the tactics, training, best applications, and heuristics to learn how to set up organizational processes that are based on industry methods. In the outer layer, workers/learners access the strategies, education, case studies, and meta-knowledge to learn how to utilize professional practices to apply industry methods. Note that the learning resources in these layers are aligned but there is not a one-to-one mapping between layers. For example, one strategy at the professional practice layer may align with many tactics at the industry methods layer. And one tactic at the industry methods layer may align with many process steps at the organizational layer. The same one-to-many mappings from the professional practices layer, to the industry methods layer, to the organizational processes layer are also true for the other learning resources.

### BRIEF DESCRIPTION OF THE DRAWINGS

FIG. 1. shows the two main types of business processes for this invention.

FIG. 2. shows how the invention “layers” and aligns work processes and learning resources.

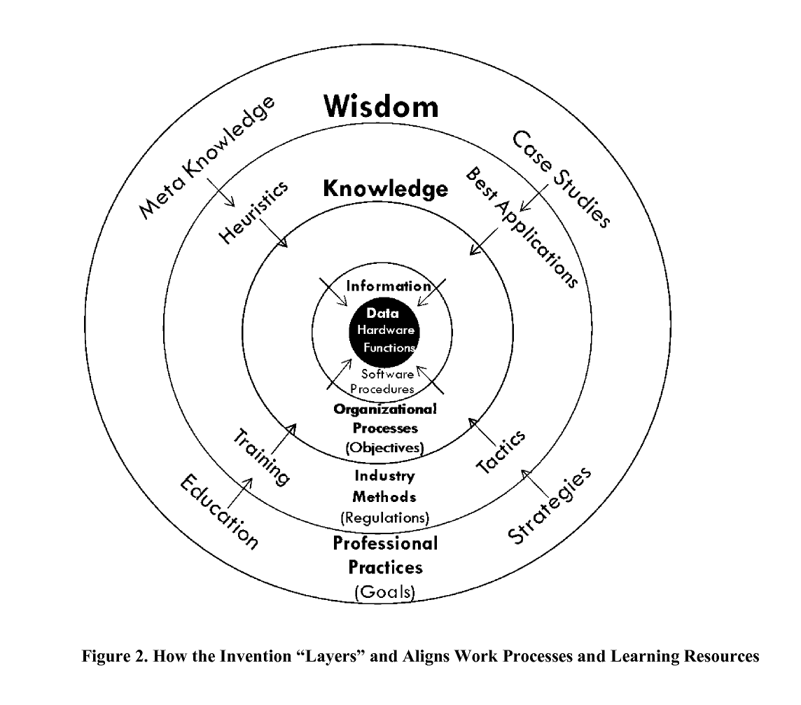

FIG. 3. shows the software implementation of the “learning while working” process-oriented learning management system.

FIG. 4. shows a cash disbursement system for churches, taken from Vargo, 1995.

FIG. 5. shows the “learning while working” process.

FIG. 6. shows the home screen for the cash disbursement system for churches.

FIG. 7. shows selecting the requisition slip template.

FIG. 8. shows filling out the requisition slip.

FIG. 9. shows the new saved requisition slip.

FIG. 10. shows assessing learning assets to learn to write a requisition slip.

FIG. 11. shows links to the learning assets for authoring a requisition slip.

FIG. 12. shows the email message sent to reviewers.

FIG. 13. shows the task assigned to reviewers.

FIG. 14. shows reviewer input.

FIG. 15. shows customized logic developed for the workflow feature of SharePoint.

FIG. 16. shows that a larger process is made by connecting many “working while learning” processes.

FIG. 17. shows the update learning assets process.

FIG. 18. shows the training while working process.

FIG. 19. shows accessing the training while working course.

FIG. 20. shows access to training assets in the training while working course.

FIG. 21. shows the update training assets process.

FIG. 22. shows education while working process.

FIG. 23. shows accessing the education while working course.

FIG. 24. shows access to educational assets in the education while working course.

FIG. 25. shows the update educational assets process.

### DETAILED DESCRIPTION OF THE INVENTION

### Software Implementation

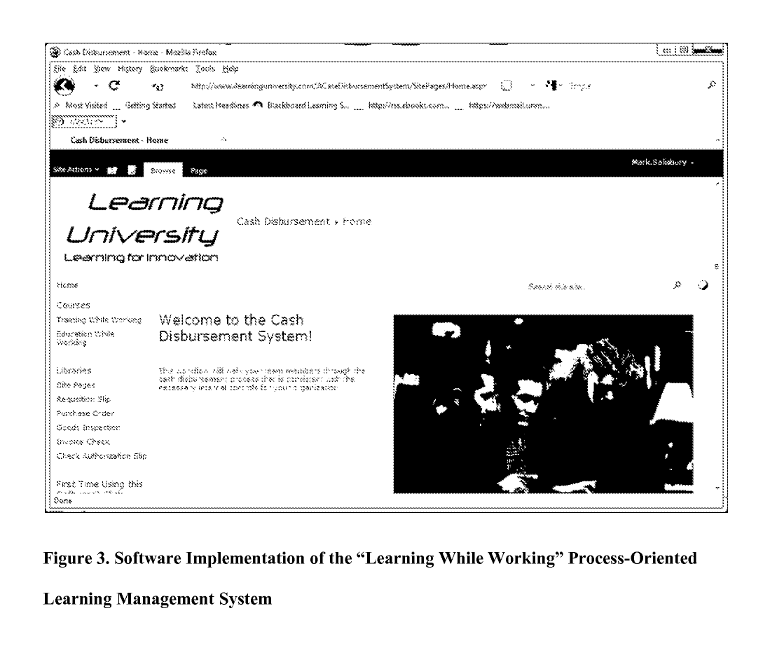

FIG. 3 shows the “Learning While Working” Process-Oriented Learning Management System. It has been implemented using Microsoft's SharePoint 2010 server application. It was built using the standard features of SharePoint 2010 and with customized logic that has been developed for the workflow feature of SharePoint to automate the collaborative processes. Screen shots of the resulting system will be presented in the description of the system below. FIG. 3 shows the home screen for the example application, “cash disbursement system for churches,” that utilizes the learning while working process-oriented learning management system.

### Description of how the Invention Works

Learning while Working Process

As a working example for this patent application, consider a collaborative business process for ordering supplies in a church organization that has been put in place to insure internal controls for the church organization. This learning while working example shows how this process-oriented learning management system can facilitate collaborative processes while providing just-in-time access to learning resources for workers to learn how to complete those processes.

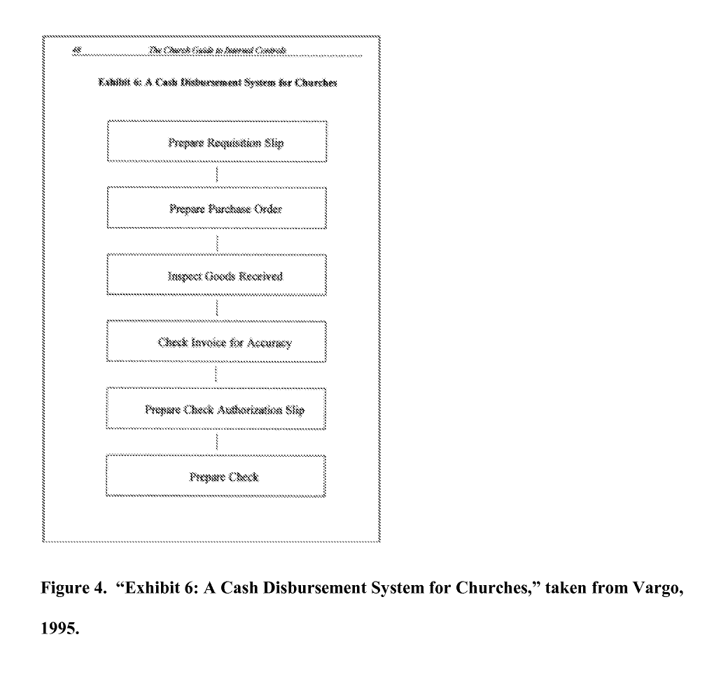

FIG. 4, entitled “Exhibit 6: A Cash Disbursement System for Churches,” taken from Vargo, 1995, shows the major steps for a collaborative business process for purchasing products and services in a church organization. In each one of these steps, a “knowledge product” is created. The term “knowledge product” refers to some kind of item that contains decisions and information. Common examples of knowledge products are design documents, quality plans, and product testing reports. These items, or knowledge products, are typically created in a collaborative business process where one member creates an item, others review it and provide feedback, and someone with the proper authority approves it. In the next few paragraphs, the knowledge products are a requisition slip, a purchase order, a goods inspection report, an invoice verification report, and a check authorization slip.

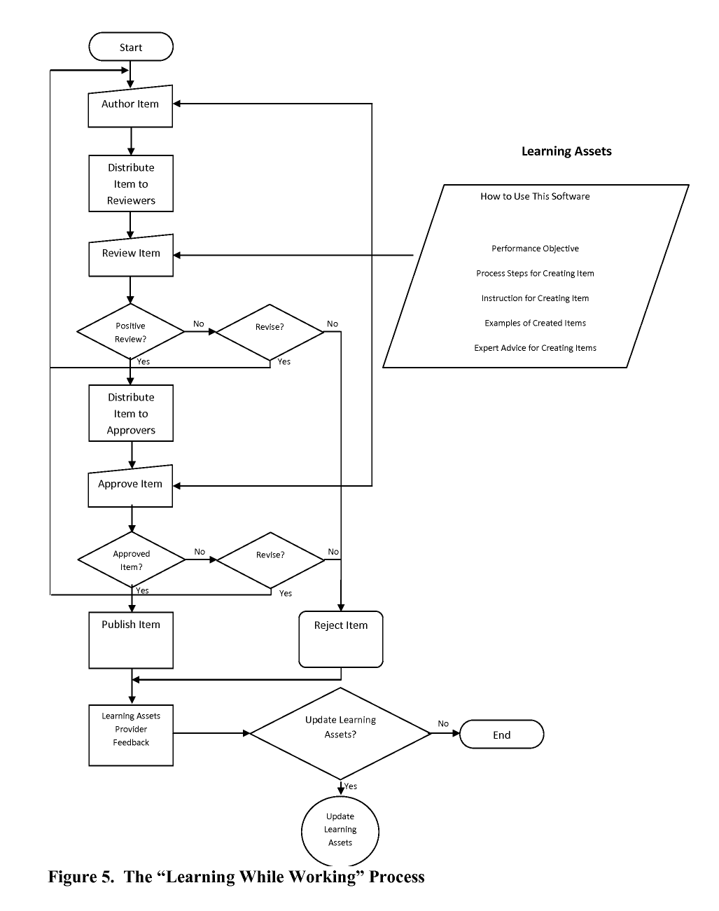

FIG. 5 shows how a “learning while working” process-oriented learning management system facilitates organizational processes by providing collaboration features, just-in-time learning, capture of lessons learned, and evaluation and recording of individual and team learning. The learning while working process is pictured on the left hand side of FIG. 5—showing the major steps of authoring, reviewing, and approving an item (which can also be thought of as a knowledge product). The learning assets are pictured on the right hand side of FIG. 5. They are a group of learning resources that the workers/learners can access to learn how to achieve the performance objective of the learning while working process. In the working example for this patent application, the performance objective for this collaborative team is to “Fill out a requisition slip completely and accurately for a request of a needed product or service that falls within the current budget.” This performance objective is one of several performance objectives that relate to a cash disbursement system for churches. The other performance objectives relate to developing a requisition slip, a purchase order, a goods inspection report, an invoice verification report, and a check authorization slip.

The Item Creation Steps for this working example are the steps needed to complete a requisition slip (i.e., what needs to be done). The Instruction for Creating Item for this working example is a brief introduction to the principles that need to be addressed in a well written requisition slip (i.e., why it needs to be done). The Examples of Created Item for this working example are previously approved requisition slips (i.e., how it needs to be done). The Expert Advice for Creating Items for this working example provides the “little nuggets” of advice for creating a well written requisition slip (i.e., when and where it needs to be done). See Appendix A for examples of these learning assets.

### System Operation

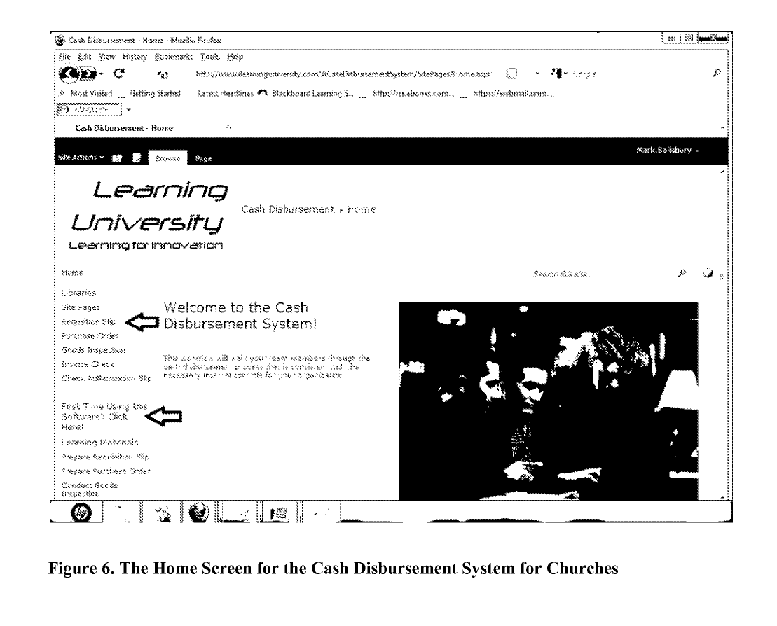

FIG. 5 shows that the learning while working process begins when one member of the organization authors an item (or knowledge product). As an example for this patent application, this initial item can be a requisition slip from a member of the church organization that represents a purchase request. During the authoring process the member has direct access to the learning assets for preparing a requisition slip. There is also help for using the software that is built in. If a worker/learner clicks on the “First Time Using this Software? Click Here!” link, he or she is provided with step-by-step instructions for using the software. (See Appendix B—First Time Using this Software Tutorial to see what this embedded help looks like.) FIG. 6 also shows the link that a worker/learner would click to begin the process of writing a requisition slip.

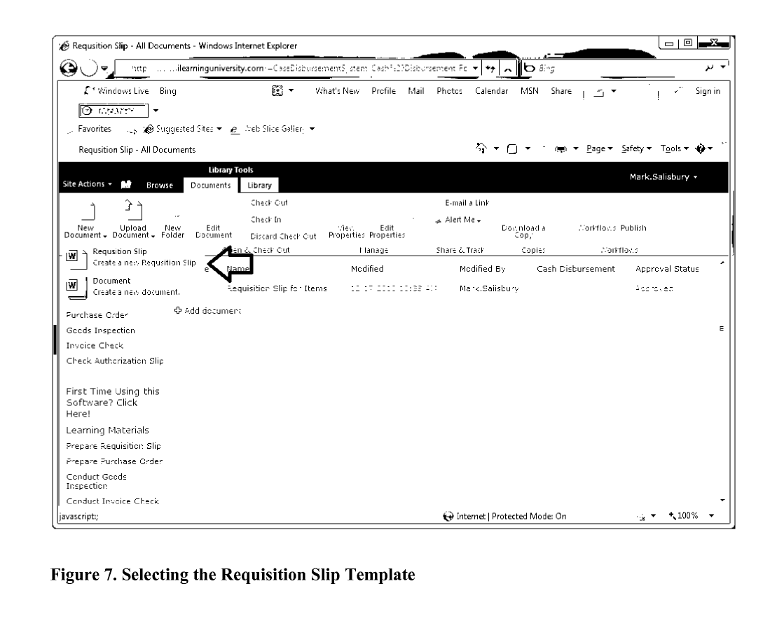

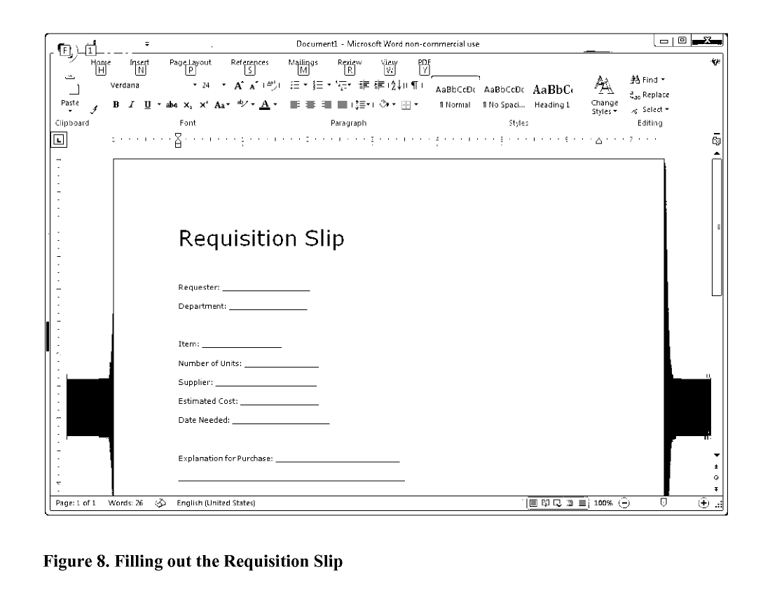

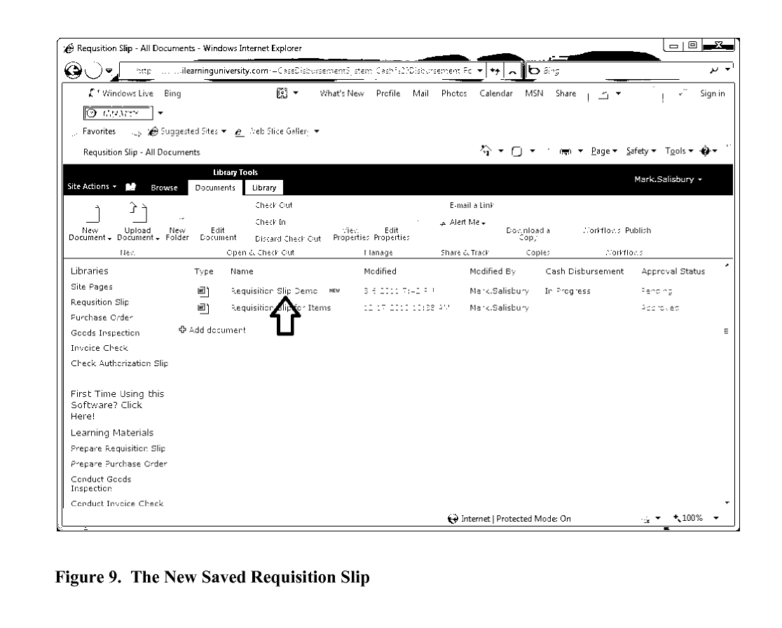

FIGS. 7 and 8 show that after the worker/learner goes to the requisition slip library, he or she uses the system to access a template for creating a requisition slip. FIG. 9 shows the completed requisition slip after it is saved to the Requisition Slip library.

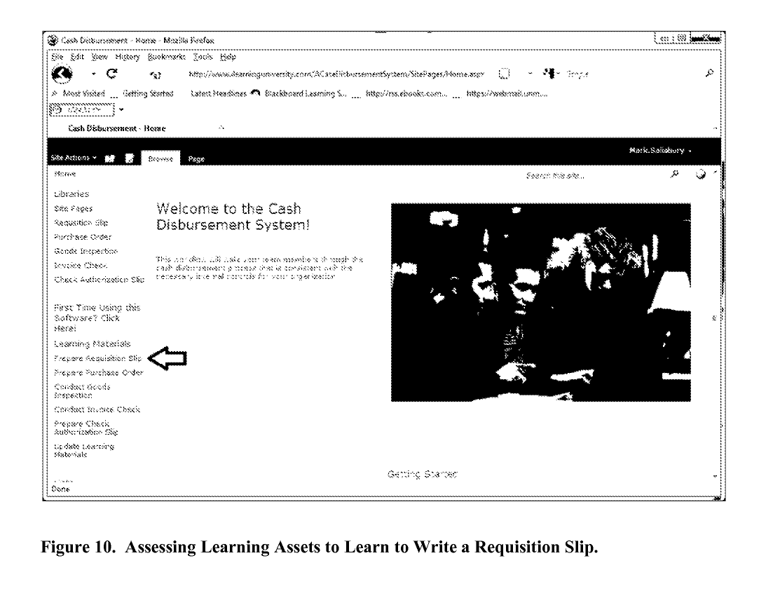

FIG. 10 shows where the worker/learner can go for help if he or she does not know how to write a requisition slip. He or she simply clicks the “Prepare Requisition Slip” link under the “Learning Materials” label.

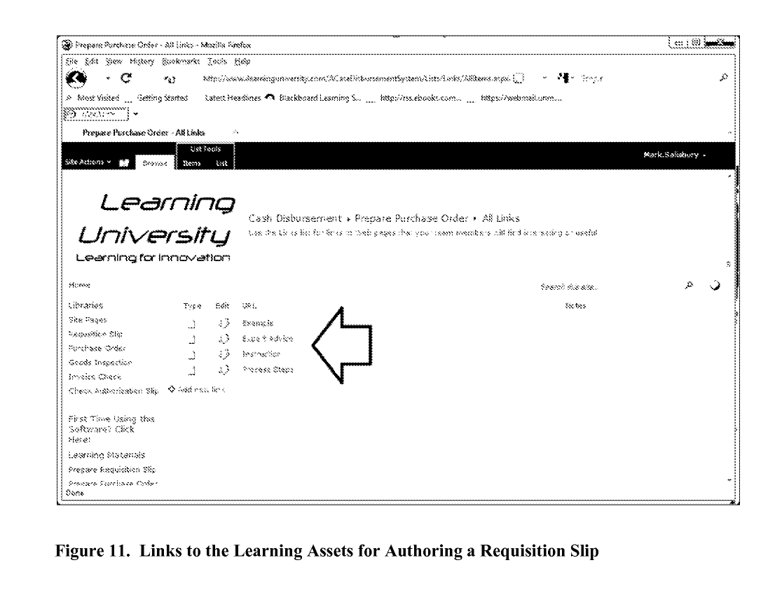

FIG. 11 shows the links along the left hand side of the screen to all the learning assets for authoring the item—in this case, authoring a requisition slip. If the author has never written a requisition slip before, he or she can look at the Process Steps (the process steps needed to complete a requisition slip), the Instruction (the principles that need to be addressed in a well written requisition slip), the Examples (the previously approved requisition slips), and the Expert Advice (the “little nuggets” of advice for creating a well written requisition slip). In this way, the church member has all the resources he or she needs to learn how to write a well written requisition slip. Alternatively, if the author is somewhat familiar with writing requisition slips but uncertain of some of the specifics or details, the author may access only some of the learning assets. In our working example, the church member may be used to writing requisitions slips at their place of employment but not as a volunteer at the church. So, they may only look at the examples of previously approved requisitions slips. Or, in another situation, the church member may need to write a requisition slip for an infrequently purchased product. He or she can access the expert advice for writing requisition slips to see if there is any advice that relates to the infrequently purchased product. In this way, the item author can access the learning assets on an “as needed” and “just-in-time” basis for authoring an item. Again, see Appendix A—Learning Assets to see what these assets look like.

Next, in the flowchart shown in FIG. 5, the item—in this example, a requisition slip for Sunday school curriculum materials—is distributed to the reviewer(s) of the item—the director of education. In a similar situation as the author, if the reviewer has never reviewed a requisition slip before, he or she can immediately access the Item Creation Steps (the process steps needed to complete a requisition slip), the Instruction for Creating Item (the principles that need to be addressed in a well written requisition slip), the Examples of Created Item (the previously approved requisition slips), and the Expert Advice for Creating Items (the “little nuggets” of advice for creating a well written requisition slip). In this way, the director of education has all the resources he or she needs to review a requisition slip.

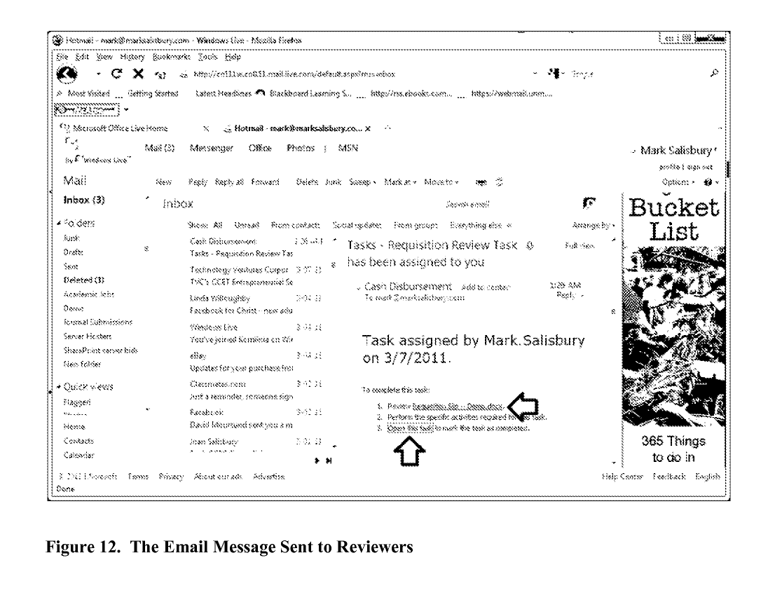

Notification and access to the newly submitted requisition slip is given to reviewers via email. FIG. 12 shows the message that reviewers get. They are assigned the “reviewer task.” If reviewers click on the “Requisition Slip—Demo.docx” link, they will open the new submitted requisition slip.

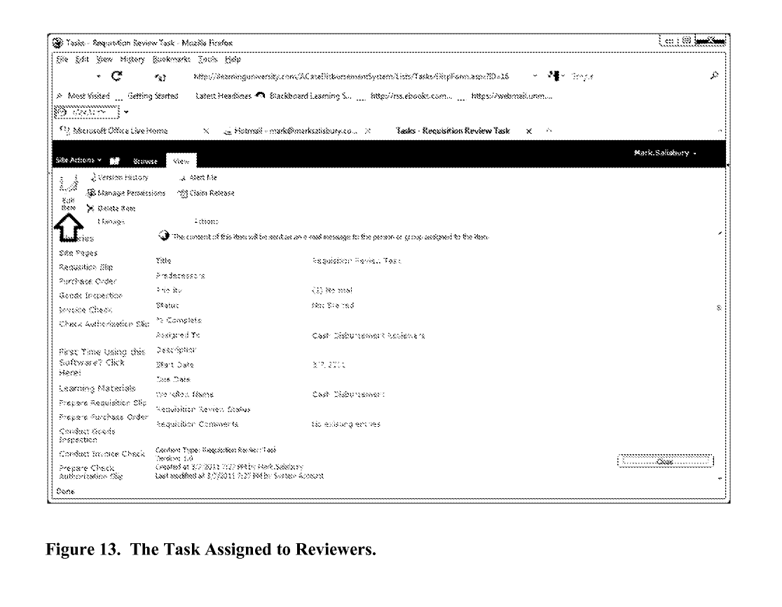

If reviewers click on the “Open this task” link in the email message they received, they will open the Requisition Slip library on the SharePoint site—shown in FIG. 13. Unseen in FIG. 13, because of scrolling, there are links along the left hand side of the screen to all the learning assets for writing, reviewing, and approving a requisition slip—the same links that can be seen in FIG. 10.

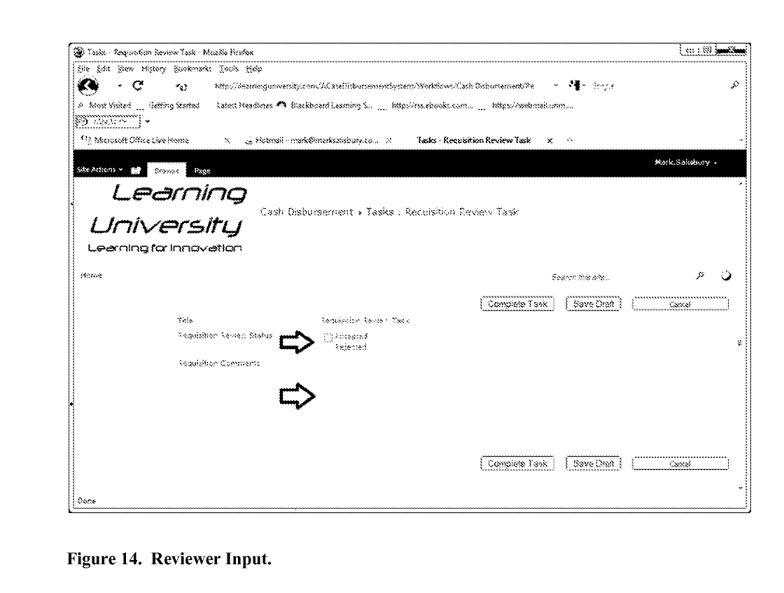

FIG. 14 shows the open task that is assigned to reviewers—waiting for two inputs. It is waiting for the reviewer to indicate if the requisition slip is accepted or rejected (a third option was later added—needs revision)—and for comments about its acceptance or rejection.

Back to FIG. 5, which shows, if the item received a positive review by the reviewers, it is routed to the person(s) with authority to approve it. The email and the assigned task for the approver(s) is very similar to the ones for the reviewer(s) and looks very much like those shown in FIGS. 12, 13, and 14. (Again, a third option has been added for the reviewer(s)—needs revision.) In this example, it would be assigned to the treasurer of the church organization. If the item received a negative review, then the next decision is to decide if it should be sent back to the author to be revised or if it should be rejected and no longer considered. In our example, it would mean that the director of education would have to decide if the requisition slip could be approved if small modifications were made to it—or if the request documented in the requisition slip was so out of line with the church organization's purchasing polices that it is rejected. If the item was judged to need revision, then it would be routed back to the author. In our example, the director of education would send it back to the church member with some directions for revising the requisition slip (say, with a request to identify a specific vendor). If the director deemed it out of scope, the director of education would indicate why it was rejected for the benefit of the church member who created the requisition slip.

FIG. 5 shows that, similar to the situation for the reviewers of an item, when the person(s) with authority to approve an item receive it, then the next decision is to decide if it should be sent back to the author to be revised or if it should be rejected. In our example, it would mean that the treasurer would have to decide if the requisition slip could be approved if small modifications were made to it—or if the request documented in the requisition slip was so out of line for the church organization that it is rejected. If the item is judged to need revision, then it would be routed back to the author. In our example, the treasurer would send it back to the church member with some directions for revising the requisition slip (like ordering fewer supplies to save money). If the treasurer deemed it out of scope, the director would indicate why it was rejected for the benefit of the church member who created the requisition slip.

FIG. 5 also shows that in a similar situation as the author and reviewer, if the approver has never approved a requisition slip before, he or she can look at the Item Creation Steps (the process steps needed to complete a requisition slip), the Instruction for Creating Item (the principles that need to be addressed in a well written requisition slip), the Examples of Created Item (the previously approved requisition slips), and the Expert Advice for Creating Items (the “little nuggets” of advice for creating a well written requisition slip). In this way, the treasurer has all the resources he or she needs to learn how to approve a requisition slip.

FIG. 5 shows that after an item is approved, it is published. For some items, publishing means it is placed on another site where a different audience has access to it. In the working example for this patent application, publishing the requisition slip does not move the document to another site, but rather makes it “public” in that the viewing permissions have to changed to indicate that it is an approved requisition slip. After it is published, an optional step is available where the provider of the learning assets can provide feedback on how the process can be improved to create a higher quality item in a shorter time period. In our example, a possible suggestion may be to add a reviewer to the review step to improve internal control for creating a requisition slip. (This could be part of the support service by the learning assets provider when assisting in the set up of the collaborative business process for ordering supplies in a church organization.)

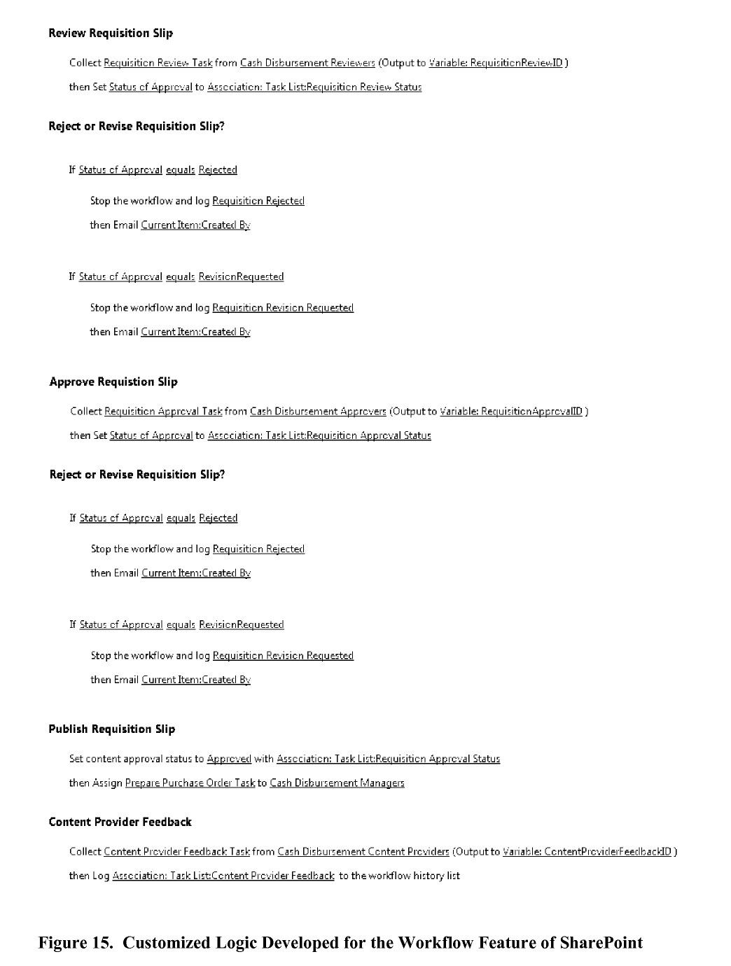

FIG. 15 shows the customized logic that has been developed for the workflow feature of SharePoint to automate the collaborative processes. It was developed in a separate application, SharePoint Designer 2010 and uploaded to the main SharePoint site. This delivers the email alerts, links to documents and learning assets, assigns tasks, and collects input from users. FIG. 15 just shows the logic of the collaborative process for creating a requisition slip. There are other similar logic sets for the other items that are created and managed in a cash disbursement system for churches—a purchase order, a goods inspection report, an invoice verification report, and a check authorization slip. And there is similar logic for the workflows at the industry methods level and professional practices level, described below.

Also, FIG. 5 shows that when a requisition slip is published, it “triggers” an alert to the person given the responsibility of writing a purchase order. That person begins an almost identical process to the writing a requisition process that was just completed. The learning while working process is the same but the learning assets are different—instead of resources for writing a requisition slip, they are resources for writing a purchase order. Similar to the situation described above for writing a requisition slip, these learning assets can be accessed by the author, reviewer(s), and approver(s) during the process of writing a purchase order where they can access the Item Creation Steps (the process steps needed to complete a purchase order), the Instruction for Creating Item (the principles that need to be addressed in a well written purchase order), the Examples of Created Item (the previously approved purchase orders), and the Expert Advice for Creating Items (the “little nuggets” of advice for creating a well written purchase order). In this way, the author, reviewer(s), and approver(s) have access to all the resources they need to learn how to create, review, and approve a purchase order. This “new process” for creating a purchase order is simply another copy of the “generic” learning while working process with new learning assets that pertain to creating a purchase order.

Using the Learning while Working Process to Create More Complex Processes

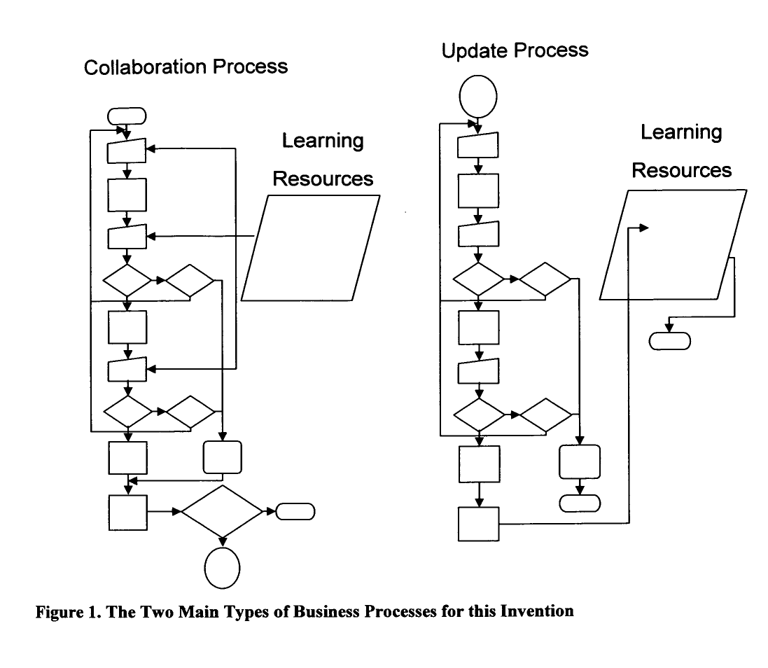

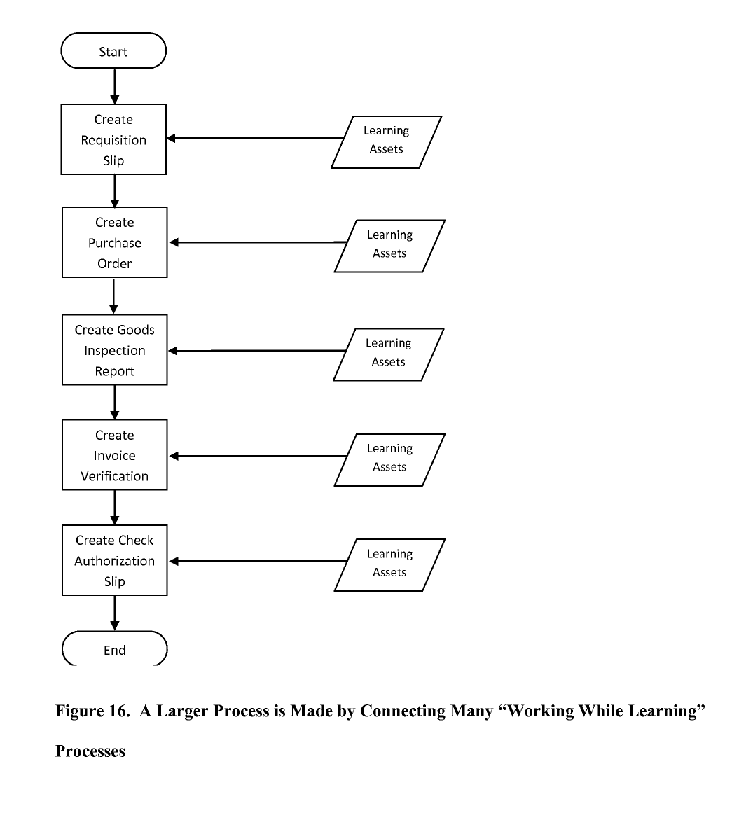

A larger process with many interrelated knowledge products can be easily created by making multiple copies of the “generic” learning while working process and substituting new learning assets that pertain to the knowledge product that is created in each process. For example, the large process depicted in FIG. 1, entitled “Exhibit 6: A Cash Disbursement System for Churches” can be created by making a learning while working process for each knowledge product of the larger process—a requisition slip, a purchase order, a goods inspection report, an invoice verification report, and a check authorization slip. FIG. 16 shows that for each of these knowledge products, a unique set of learning assets is developed and is made accessible when the learning while working process is invoked for that knowledge product. Also, with the fielded system, the email and the assigned tasks for the reviewer(s) and approver(s) are very similar to the ones like those shown in FIGS. 12, 13, and 14.

### Update Learning Assets Process

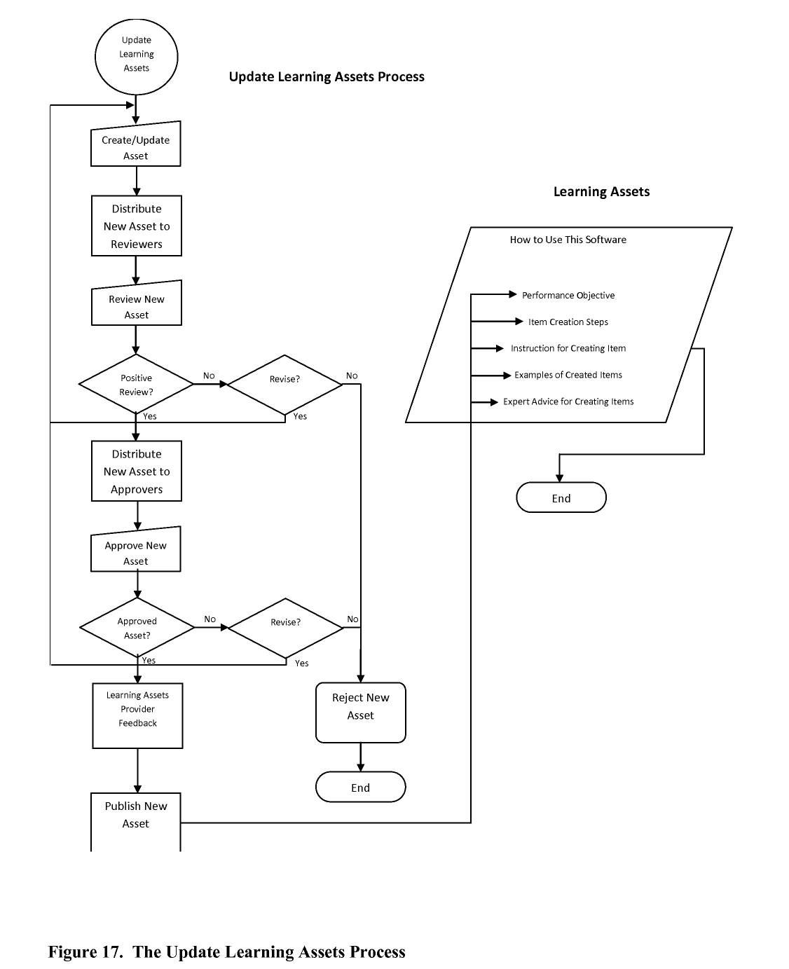

At the end of the learning while working process shown in FIG. 5 is the decision icon entitled, “Update Learning Assets.” This allows anyone involved in the learning while working process to submit an update for any of the learning assets which are accessible during the process. For example, as one of the reviewers prepares comments for the revision of a requisition slip, the reviewer recognizes that those comments may be useful for others who will later submit requisitions slips. So, the reviewer formulates those comments as expert advice and submits it for review and approval where it enters the “Update Learning Assets” process shown in FIG. 17. Note that the update learning assets process shown in FIG. 17 is essentially the learning while working process—except it is used to update the learning assets. Also, with the fielded system, the email and the assigned tasks for the reviewer(s) and approver(s) are very similar to the ones like those shown in FIGS. 12, 13, and 14.

As shown in FIG. 17, the update learning assets process begins when one member of the organization authors an item (a new learning asset or update for an existing learning asset). As an example for this patent application, this initial item is some expert advice for creating a requisition slip. Next, the item—in this example, some expert advice for creating a requisition slip for Sunday school curriculum materials—is distributed to the reviewer(s) of the item. Reviewers are made up of people knowledgeable about creating requisition slips.

If the item (expert advice for creating a requisition slip) received a positive review by the reviewers, it is routed to the person(s) with authority to approve it. In the working example, it would be the treasurer of the church organization. If the item received a negative review, then the next decision is to decide if it should be sent back to the author to be revised or if it should be rejected and no longer considered. In our example, it would mean that the reviewers would have to decide if the expert advice for creating a requisition slip could be approved if small modifications were made to it—or if the expert advice for creating a requisition slip was so out of line with the church organization's purchasing polices that it is rejected. If the item was judged to need revision, then it would be routed back to the author. In our example, the reviewers would send it back to the church member with some directions for revising the expert advice for creating a requisition slip (say, with a request to include more details). If the reviewers deemed it out of scope, the reviewers would indicate why it was rejected for the benefit of the church member who created the expert advice for creating a requisition slip.

After a new or updated learning asset is approved, it is published. (This example shows the creation of a new learning asset, the expert advice for creating a requisition slip. Another example could be the creation of a new example. Furthermore, this same process can be used to update the Item Creation Steps and Instruction for Creating Item learning assets.) For new or updated learning assets, publishing means it is placed with the other learning assets for the associated knowledge product. In the working example for this patent application, publishing the expert advice for creating a requisition slip places it in with the Expert Advice for Creating Items area of the learning while working process for creating a requisition slip. Just as with other learning while working processes, after learning assets are published, an optional step is available where the provider of the learning assets can provide feedback on how the process can be improved to create a higher quality learning asset in a shorter time period. In our example, a possible suggestion may be to add more reviewers to provide more feedback before accepting expert advice for creating a requisition slip.

Alternatively, a more informal way to update learning assets could be configured for when a review and approval process is not needed, so that a member of the organization could simply upload a new learning asset or update for an existing learning asset to the system. Then, in the Learning While Working Process, members of the organization would rate that asset after they accessed it—and their rating would be averaged and made available to organizational members when they have access to that asset at a later time.

Training while Working Process

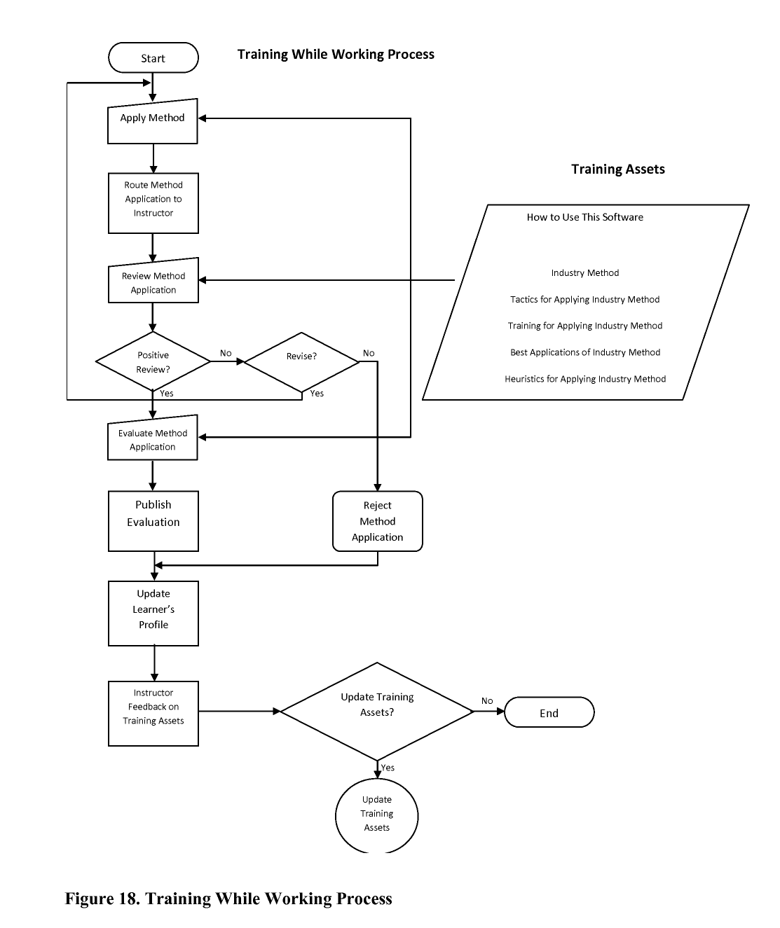

As shown in FIG. 18, training is a higher level process than filling in fields for a requisition slip. Instead of focusing on individual performance objectives for organizational processes like “Fill out a requisition slip completely and accurately for a request of a needed product or service that falls within the current budget,” training focuses on applying industry standard methods to establish organizational processes. An example industry standard method for utilizing requisition slips is to “Configure the system to ensure that the two following internal control conditions are met. 1) The proper fields and default values (such as preferred vendors) are included the requisition slip template. 2) There is a separation of duties in the review and approval process of requisitions slips.”

To create a working example of a “training while working” process for this patent application, consider a short training course on setting up a cash disbursement system in an organization. Note this is a course on setting up a cash disbursement system—not in using the system which the learning assets in FIG. 5 focused on. Such a course would cover the standard industry methods shown in FIG. 1, entitled “Exhibit 6: A Cash Disbursement System for Churches”—a requisition slip, a purchase order, a goods inspection report, an invoice verification report, and a check authorization slip. To successfully set up a cash disbursement system and complete the training, students apply each of these standard industry methods. Worker/learners of the training apply the methods and instructors review, provide feedback, and evaluate the method applications.

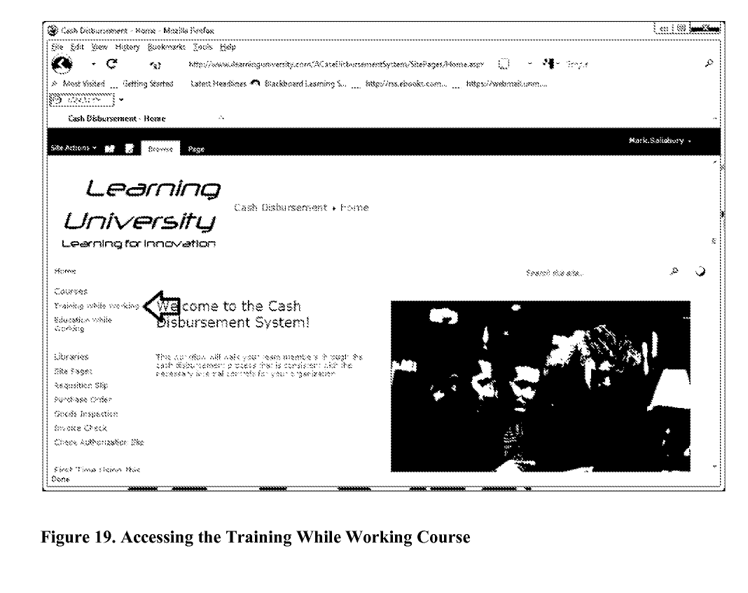

FIG. 19 shows that a member of the “learning while working” cash disbursement system for churches, can click on the link “Training While Working” and go to the training course for developing a cash disbursement system. The assumption is that the member has made arrangements to be in the training course and that he or she will complete the course by applying standard industry methods to setup a cash disbursement system for a church.

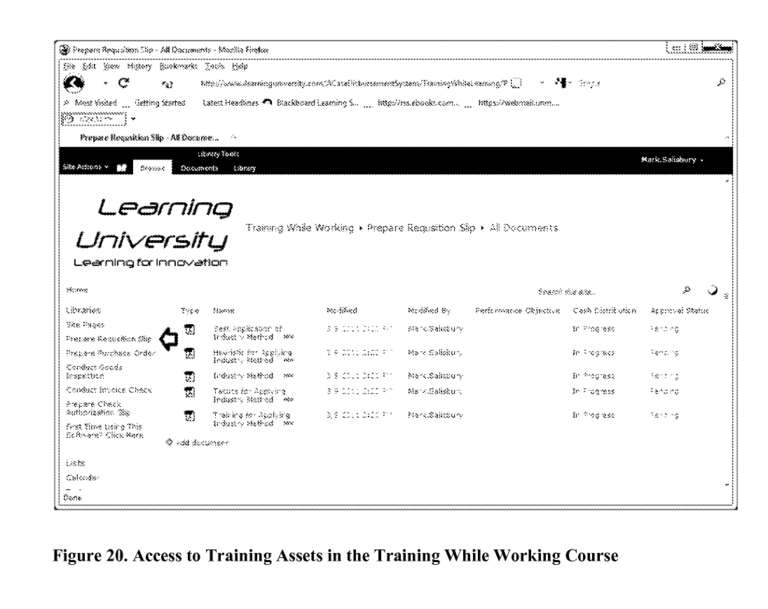

FIG. 18 shows that the training while working process begins when one member of the training course applies a standard industry method. As an example for this patent application, this initial method application can be the creation of a requisition slip template and setting the permissions for author(s), reviewer(s), and approver(s) for the separation of duties by a member of the course. During the method application process, the course member has direct access to the training assets for creating a requisition slip template and setting the permissions for author(s), reviewer(s), and approver(s)—the Tactics for Applying Industry Method, the Training for Applying Industry Method, Best Applications of Industry Method, and the Heuristics for Applying Industry Method. FIG. 20 shows that in a similar way to the learning while working process, the training while working process provides access to training resources so the worker/learner can learn to complete the task at hand—create a requisition slip template and set up permissions for the authors, the reviewers, and the approvers of requisition slips. In this working example, shown in FIG. 20, the worker/learner has clicked on the “Prepare Requisition Slip” link to go these training assets. See Appendix C for the details of these training assets. Note that the “Tactic” document in Appendix C provides all the steps for creating a requisition slip template and setting up the access permissions for the author(s), the reviewer(s), and the approver(s). It also shows how the system supports those collaboration features.

Next, in the flowchart shown in FIG. 18, the applied method—in this example, a requisition slip template and permission settings—is distributed to the instructor of the course. In a similar situation as the course member has in creating a requisition slip template and permission settings, the instructor can use the training assets to review the applied method for creating a requisition slip template and permission settings. In this example, the instructor looks at the Tactics for Applying Industry Method, the Training for Applying Industry Method, Best Applications of Industry Method, and the Heuristics for Applying Industry Method in respect to creating a requisition slip template and setting up the author, reviewer(s), and approver(s) access permissions. In this way, the course instructor has all the resources he or she needs to review the requisition slip template and access permissions (to determine if they meet the internal control requirements).

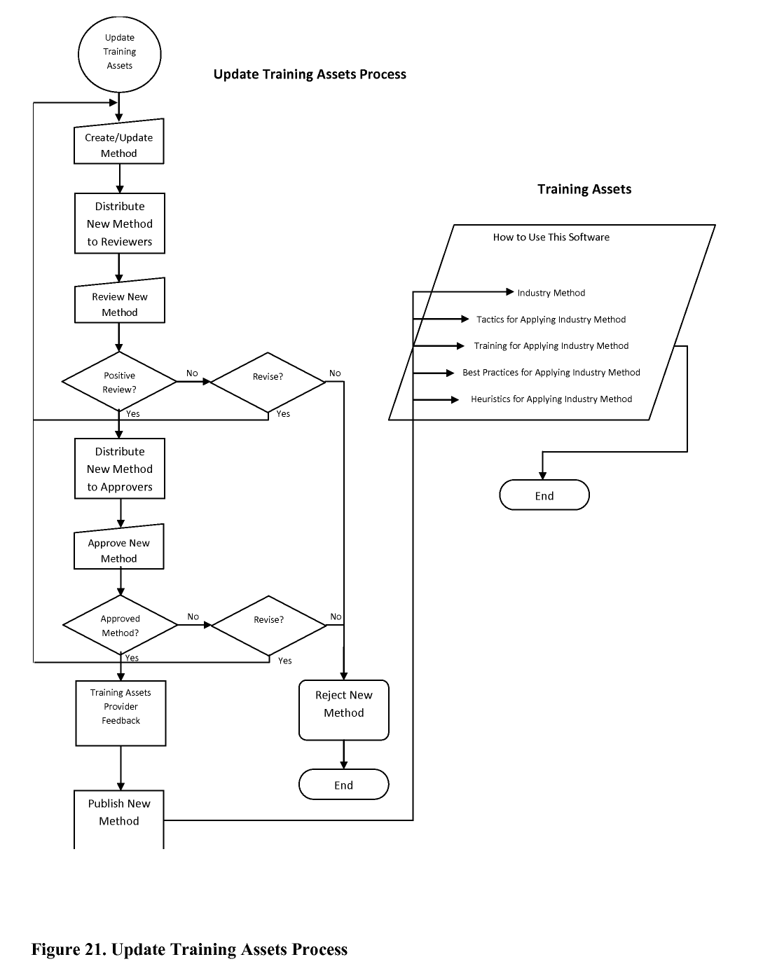

As shown in FIG. 21, if the assignment received a positive review by the instructor, then it is evaluated (given a score). If the item received a negative review, then the next decision is to decide if it should be sent back to the course member to be revised or if it should be rejected as a successful applied method. In our example, it would mean that the instructor would have to decide if the requisition slip template and permission settings could receive a passing score if small modifications were made to them—or if the request the requisition slip template and permission settings were so out of line with the evaluation criteria that they were rejected.

After a course member's applied method is assigned a passing score, the member's profile is updated to indicate successful application of that method. If this is the last successful application of a method for a training course, then the update of the learner's profile shows that the entire course has been completed and notifies the course administrator and the course member.

### Update Training Assets Process

As shown in FIG. 21, the “Update Training Assets” process is very similar to the update learning assets process described above. It begins when one instructor of the course authors an item (a new training asset or update for an existing training asset). As an example for this patent application, this initial item is a heuristic for creating a requisition slip template. Next, the item is distributed to the reviewer(s) of the item—the developer(s) and owner(s) of the training assets.

If the item (a heuristic for creating a requisition slip template) received a positive review by the reviewers, it is routed to the person(s) with authority to approve it. In the working example, it would be the designer of the training course for cash disbursement in a church organization. If the item received a negative review, then the next decision is to decide if it should be sent back to the author to be revised or if it should be rejected and no longer considered. In our example, it would mean that the reviewers would have to decide if the a heuristic for creating a requisition slip template could be approved if small modifications were made to it—or if the a heuristic for creating a requisition slip template was so out of line with the tactics for creating a requisition slip template that it is rejected. If the item was judged to need revision, then it would be routed back to the author. In our example, the reviewers (training course designer) would send it back to the instructor with some directions for revising the heuristic for creating a requisition slip template (say, with a request to include more details). If the reviewers deemed it out of scope, the reviewers would indict why it was rejected for the benefit of the instructor who created the heuristic for creating a requisition slip template.

After a new or updated training asset is approved, it is published. For new or updated training assets, publishing means it is placed with the other training assets for the application of a standard industry method. In the working example for this patent application, publishing the heuristic for creating a requisition slip template places it in with the Heuristics for Applying Industry Method area of the training while working process for creating a requisition slip.

Using the Training while Working Process to Create More Complex Processes

As with the organizational level, a larger process with many interrelated industry methods can be easily created by making multiple copies of the “generic” training while working process and adding new training assets that pertain to the method that is applied in each working process. This would look like the process depicted in FIG. 16, except that for each of these industry methods, a unique set of training assets are developed and made accessible when the training while working process is invoked for that method. Also, with the fielded system, the email and the assigned tasks for the reviewer(s) and approver(s) are very similar to the ones like those shown in FIGS. 12, 13, and 14.

Education while Working Process

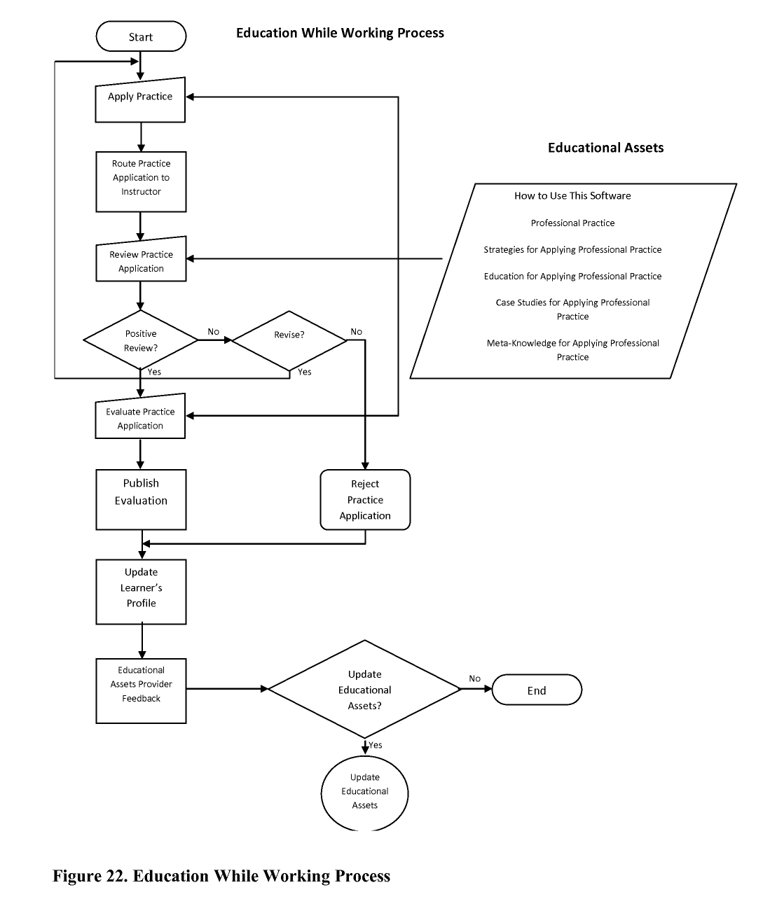

As shown in FIG. 22, education is yet a higher level process than training Instead of focusing on taking standard industry methods and applying them to organizational processes, education focuses on applying professional practices to standard industry methods—which in turn, are applied to organizational processes. An example professional practice for purchases and cash disbursement is to “Update the existing system design or create a new system design that correctly addresses the six categories of physical control activities specified by the American Institute of Certified Public Accountants (AICPA) in the Statements on Auditing Standards (SAS) 78.”

To create a working example of an “education while working” process for this patent application, consider a college credit course on designing a purchases and cash disbursement system with strong internal controls. Such a course would cover how to apply the professional practices to the current situation the course member was facing with his or her organization. Course members apply each of the professional practices to successfully design or modify the design of a cash disbursement system and complete the education course. Worker/learners of the education experience apply the professional practices and instructors review, provide feedback, and evaluate how successful the practices have been applied.

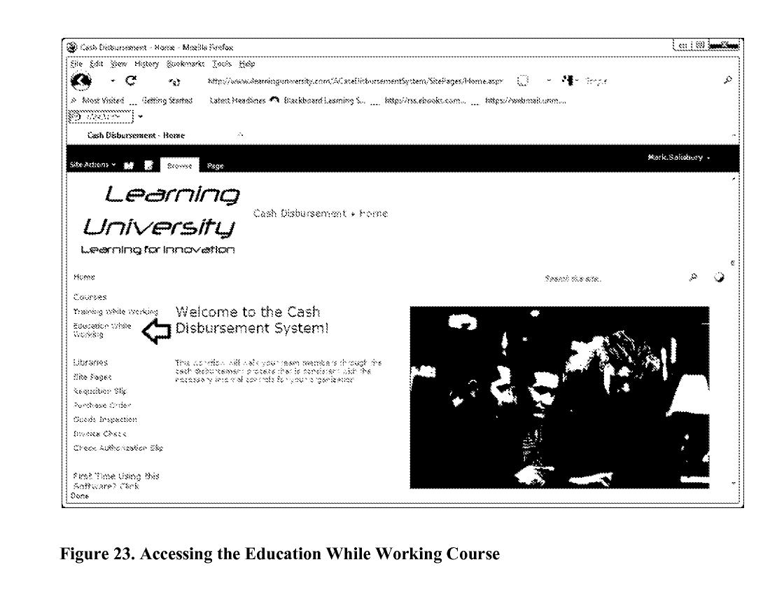

FIG. 23 shows that a member of the “learning while working” cash disbursement system for churches, can click on the link “Education While Working” and go to the education course for designing a purchases and cash disbursement system. The assumption is that the member has made arrangements to be in the education course and that he or she will complete the course by applying professional practices to design—or modify the design—of a cash disbursement system for an organization. This is a “high level” course on professional practices—possibly, a course offered for college credit through an accredited business school.

Note that students may elect to take this course in conjunction with the training course described above knowing that each professional practice aligns with one or more standard industry methods at the industry methods layer, which in turn, align with one or more performance objectives at the organizational process layer. This alignment of practices to methods to performance objectives is one of the unique aspects of this proposed invention. It makes it possible for users to put “theory into practice” by ultimately realizing professional practices in organizational processes.

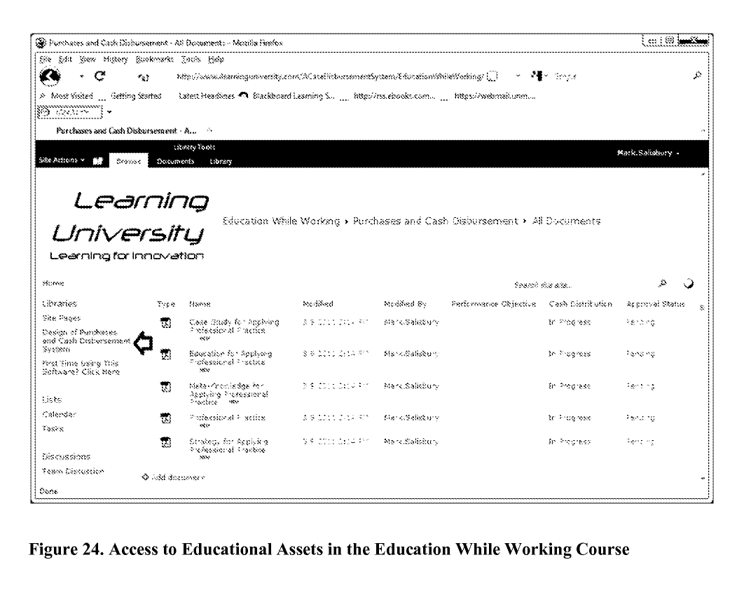

As FIG. 22 shows, the education while working process begins when one member of the training course applies a professional practice. As an example for this patent application, this professional practice is applied to update an existing system design or create a new system design that correctly addresses the six categories of physical control activities. During the professional practice application process, the course member has direct access to the educational assets for updating an existing system design or creating a new one—the Strategies for Applying Professional Practice, the Education for Applying Professional Practice, Case Studies for Applying Professional Practice, and the Meta-Knowledge for Applying Professional Practice. FIG. 24 shows that in a similar way to the training while working process, the education while working process provides access to learning resources so the worker/learner can learn to complete the task at hand—updating an existing system design or creating a new one. In this working example, shown in FIG. 24, the worker/learner has clicked on the “Design of Purchases and Cash Disbursement System” link to go these educational assets. See Appendix D for the details of these educational assets. Note that the educational assets in Appendix D come from Hall, 2008, and are abbreviated to save space in this patent application. The idea behind putting them in the appendix is to show that a member of the education course has all the resources he or she needs to update an existing system design or create a new one.

Next, in the flowchart shown in FIG. 22, the applied practice—in this example, updating an existing system design or creating a new one—is distributed to the instructor of the course. In a similar situation to the course member who is updating an existing system design or creating a new one, the instructor can use the education assets to review the applied practice for updating an existing system design or creating a new one. In this example, the instructor looks at the Strategies for Applying Professional Practice, the Education for Applying Professional Practice, Case Studies for Applying Professional Practice, and the Meta-Knowledge for Applying Professional Practice in respect to updating an existing system design or creating a new one. In this way, the course instructor has all the resources he or she needs to review a system design and provide feedback.

As shown in FIG. 22, if the assignment received a positive review by the instructor, then it is evaluated (given a score). If the item received a negative review, then the next decision is to decide if it should be sent back to the course member to be revised or if it should be rejected as a successful applied practice. In our example, it would mean that the instructor would have to decide if the system design would receive a passing score if small modifications were made to it—or if the system design is so out of line with the evaluation criteria that it is rejected.

After a course member's applied practice is assigned a passing score, the member's profile is updated to indicate successful application of that practice. If this is the last successful application of a practice for an education course, then the update of the learner's profile shows that the entire course has been completed and notifies the course administrator and the course member.

### Update Education Assets Process

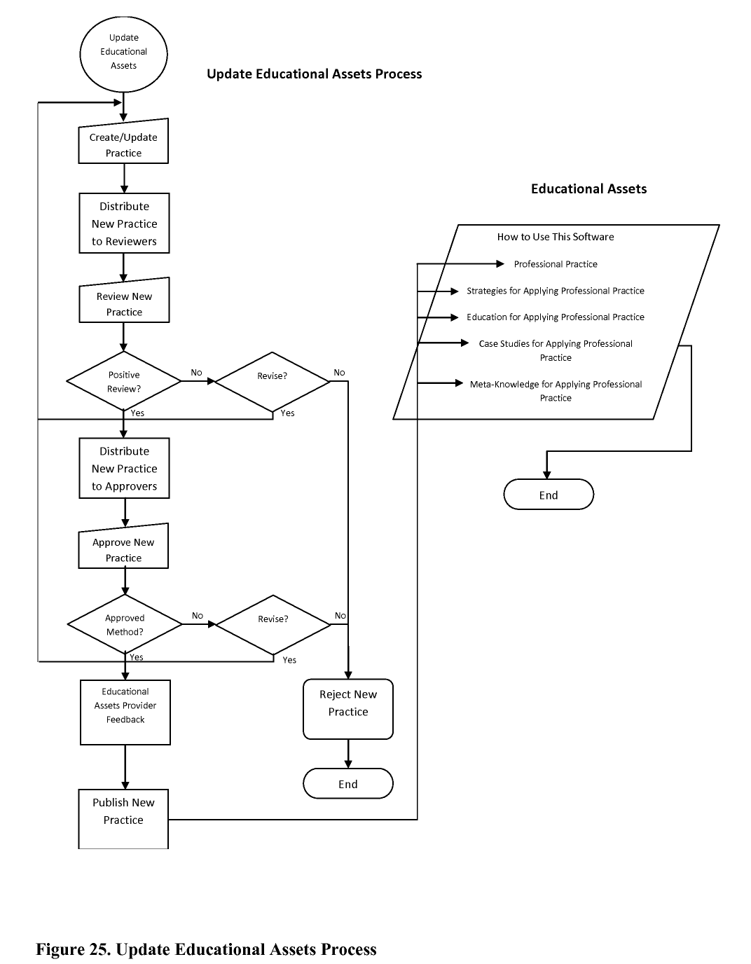

As shown in FIG. 25, the “Update Education Assets” process is very similar to the update training assets process described above. It begins when one instructor of the course authors an item (a new educational asset or an update for an existing educational asset). As an example for this patent application, this initial item is a case study for applying a professional practice. Next, the item is distributed to the reviewer(s) of the item—the developer(s) and owner(s) of the educational assets.

If the item (case study for applying a professional practice) received a positive review by the reviewers, it is routed to the person(s) with authority to approve it. In the working example, it would be the designer of the education course for designing a purchases and cash disbursement system. If the item received a negative review, then the next decision is to decide if it should be sent back to the author to be revised or if it should be rejected and no longer considered. In our example, it would mean that the reviewers would have to decide if the case study for applying a professional practice could be approved if small modifications were made to it—or if the a case study for applying a professional practice was so out of line with the other case studies for applying the professional practice that it is rejected. If the item was judged to need revision, then it would be routed back to the author. In our example, the reviewers would send it back to the instructor with some directions for revising the case study for applying a professional practice (say, with a request to include more details). If the reviewers deemed it out of scope, the reviewers would indict why it was rejected for the benefit of the instructor who created the case study for applying a professional practice

After a new or updated educational asset is approved, it is published. For new or updated educational assets, publishing means it is placed with the other educational assets for the application of a professional practice. In the working example for this patent application, publishing case study for applying a professional practice places it in with the Case Studies for Applying Professional Practice area of the education while working process.

Using the Education while Working Process to Create More Complex Processes

As with the organizational and training layers, a larger process with many interrelated professional practices can be easily created by making multiple copies of the “generic” education while working process and adding new educational assets that pertain to the professional practice that is created in each working process. Again, this would look like the process depicted in FIG. 16, except that for each of these professional practices, a unique set of educational assets are developed and made accessible when the education while working process is invoked for that professional practice. Also, with the fielded system, the email and the assigned tasks for the reviewer(s) and approver(s) are very similar to the ones like those shown in FIGS. 12, 13, and 14.

### Alternate Ways of Implementing the Invention

The “Learning While Working” Process-Oriented Learning Management System has been implemented using Microsoft's SharePoint 2010 server application for this patent application. However, there are many other ways the Learning While Working Process-Oriented Learning Management System could be implemented to achieve its unique result. SharePoint Designer was used to show the logic behind the invention. However, an “App based” approach could also be used to implement the invention. SharePoint 2013 supports Apps. So, if a developer knows how to build a web application, then that developer knows how to build an App for SharePoint. A developer could use any language, such as HTML, JavaScript, PHP, or .NET, and could also use web development tools, including Microsoft Visual Studio 2012 to implement the invention.

Another way is that the invention could be implemented is by using another document and collaboration system such as the one offered by Google Docs. And, it could be implemented using more “basic” web technologies such as creating it as .asp pages or with a general scripting language like Cold Fusion or PHP. These alternatives could be used to develop the web pages and develop the computer logic to automate the collaborative processes.

### Potential Commercial Uses of the Invention

The “Learning While Working” Process-Oriented Learning Management System described in this patent application has many potential commercial uses that include—but are not limited to—the following potential uses. One potential commercial and the best mode of use is to offer it as a licensed product or service to organizations to manage their own proprietary knowledge within their own organization's processes. Another potential commercial use is to employ it as a vehicle to offer educational and training content on professional practices and standard industry methods to organizations. It would be used to “package” and deliver the educational and training content to organizations that desire to directly integrate professional practices and standard industry methods into their organizational processes. Another potential commercial use is to employ it as a “single platform” learning management system to integrate proprietary knowledge created and managed within organizations with training provided by third party suppliers and with educational offerings supplied by higher educational providers. With this invention, organizations can align, integrate, and manage all of their learning for their members—informal, training, and educational in one single format and platform.

What is claimed is:

1. A learning management process comprising the steps of: managing a collaborative work process; providing just-in-time access to learning resources for workers to learn how to complete the work products that are intended to result from the collaborative work process; collaborating work process for users to collaboratively submit, review, and approve work products; accessing with a computer, files that serve as learning resources that the worker/learners of the collaborative work process use to learn how to complete the work products; and updating the work process where worker/learners collaborate to create/update, review, and approve the learning resources.

2. A learning management system, according to claim 1, wherein said process has the capability to assign users to the roles of submitter, reviewer, and approver of updates, modifications, deletions, and additions to the learning resources.

3. A learning management process, according to claim 1, wherein said process provides ready access to a learning resource that tells the worker/learner WHAT to do in the completion of a work product in the collaborative work process.

4. A learning management process, according to claim 1, wherein said process provides ready access to a learning resource that tells the worker/learner WHY complete a work product from in the collaborative work process.

5. A learning management process, according to claim 1, wherein said process provides ready access to a learning resource that tells the worker/learner HOW to complete a work product in the collaborative work process.

6. A learning management process, according to claim 1, wherein said process provides ready access to a learning resource that tells the worker/learner WHEN and WHERE to complete a work product in the collaborative work process.

7. A learning management process, according to claim 1, wherein said process provides ready access to learning resources for workers to learn how to complete the learning objective that results in the completion of a work product from the collaborative work process.

8. A learning management process, according to claim 1, wherein said process provides ready access to training resources for workers to learn how to complete the training objective that results in the completion of a work product from the collaborative work process.

9. A learning management process, according to claim 1, wherein said process provides ready access to education resources for workers to learn how to complete the education objective that results in the completion of a work product from the collaborative work process.

10. A learning management process, according to claim 1, wherein said process provides ready access to learning resources of Item Creation Steps, Instruction for Creating Item, Examples of Created Item, and the Expert Advice for Creating Items for worker/learners to complete a learning objective.

11. A learning management process, according to claim 1, wherein said process provides ready access to training resources of Tactics for Applying Industry Method, Training for Applying Industry Method, Best Applications of Industry Method, and Heuristics for Applying Industry Method for worker/learners to complete a training objective.

12. A learning management process, according to claim 1, wherein said process provides ready access to training resources of Best Applications of Strategies for Applying Professional Practice, the Education for Applying Professional Practice, Case Studies for Applying Professional Practice, and the Meta-Knowledge for Applying Professional Practice for worker/learners to complete an education objective.

13. A learning management process, according to claim 1, wherein said process provides an “update process” to the collaborative work process where worker/learners collaborate to create/update, review, and approve Item Creation Steps, Instruction for Creating Item, Examples of Created Item, and the Expert Advice for Creating Items.

14. A learning management process, according to claim 1, wherein said process provides an “update process” to the collaborative work process where worker/learners collaborate to create/update, review, and approve Tactics for Applying Industry Method, Training for Applying Industry Method, Best Applications of Industry Method, and Heuristics for Applying Industry Method.

15. A learning management process, according to claim 1, wherein said process provides an “update process” to the collaborative work process where worker/learners collaborate to create/update, review, and approve Best Applications of Strategies for Applying Professional Practice, the Education for Applying Professional Practice, Case Studies for Applying Professional Practice, and the Meta-Knowledge for Applying Professional Practice.

16. A learning management system, comprising: a capability to manage a large number of collaborative work processes; integrates learning, training, and education on a single platform; embeds help for using the software into the work processes the software manages.

17. A learning management system, according to claim 16, wherein said system provides a capability to develop larger systems made of collaborative work processes by connecting multiple collaborative work processes.

18. A learning management system, according to claim 16, wherein said system integrates learning, training, and education resources for workers to learn how to complete the work products that are intended to result from the collaborative work process by access to learning resources to achieve learning objectives, access to training resources to achieve training objectives, and access to education resources to achieve education objectives.

19. A learning management system, according to claim 16, wherein said system incorporates into collaborative work processes just-in-time access to instructions to advance the computer program, add data, delete data in a “how to use this software” help button.
